(19) United States
(12) Patent Application Publication
(10) Pub. No.: US 2018/0189251 A1
(43) Pub. Date: Jul. 5, 2018

(54) AUTOMATIC MULTI-LINGUAL EDITING METHOD FOR CARTOON CONTENT

(71) Applicant: WEDU COMMUNICATIONS CO., LTD., Seoul (KR)

(72) Inventors: Kyu Ha Lee, Goyang-si (KR); Young Sun Lee, Incheon (KR)

(73) Assignee: WEDU COMMUNICATIONS CO., LTD., Seoul (KR)

(21) Appl. No.: 15/580,685

(22) PCT Filed: Feb. 23, 2016
(86) PCT No.: PCT/KR2016/001747

§ 371 Date: Dec. 8, 2017

(30) Foreign Application Priority Data
Jul. 14, 2015 (KR) 10-2015-0099606

(51) Int. Cl. G06F 17/24; G06F 17/21; G06T 11/20; G06T 11/60

(52) U.S. Cl. CPC G06F 17/24; G06F 17/214; G06F 17/289; G06T 11/60; G06T 11/203

(57) ABSTRACT

An automatic multi-lingual editing method for cartoon content includes: extracting, from a subtitle table, subtitle data, the number of limiting lines, and a horizontal width to be displayed in a text balloon of a current order; calculating the number of letters to be inserted into one line by using a current font size and a value of the extracted horizontal width; allocating, to a remaining subtitle variable, a text corresponding to the subtitle, and allocating zero to a variable of the number of current lines; and removing, from the remaining subtitle variable, text, which is as much as the number of letters to be inserted into one line, and updating the number of current lines by adding 1 thereto; and processing the display of the extracted subtitle in a corresponding text balloon if the number of current lines is equal to or less than the number of limiting lines.

### TECHNICAL FIELD

The present invention relates to a technique of editing cartoon contents provided on the web or cartoon contents for publication, and more specifically, to a technique of automatically editing original contents in various languages without modification.

### BACKGROUND ART

Literary works such as novels, movies, cartoons and the like are translated in various languages and cross border lines.

However, in the case of a novel or a movie, if a translator translates subtitles or contents, it is general that the subtitles or the contents may be published or used as subtitles of the movie as they are without considering font size or an area or a position for displaying text.

Contrarily, in the case of a cartoon, its editing process is quite complicated.

Although translation of a cartoon in a specific language is completed, there are many cases in which an area displaying a dialogue is drawn inside a cut in the form of a text balloon, and since the length of a dialogue is different from the others, the editor should determine a font size, the number of lines, and how to display the dialogue.

Recently, as the literary works are distributed in the form of digital media, there are cases in which subtitle data are separated to select a language and display subtitles in real-time (e.g., DVDs or the like supporting multiple languages), and in the case of contents of a cartoon, although the areas for displaying subtitles are set in advance, the length of a dialogue translated in a language is different from those of the other languages, and therefore, there is a problem in that a dialogue is extended to be longer than the area of a text balloon in the horizontal direction or the number of lines is increased downward, and the dialogue is shown to be overlapped with the area displaying the picture.

That is, there are cases in which dialogue contents invade an area displaying a picture, and therefore, there may be a problem of readability, which makes it difficult to properly read the dialogue, and there are cases in which it is difficult to properly enjoy the cartoon since the pictures are hidden in the process of changing languages.

Therefore, in the case of cartoon contents, dynamically selecting and changing a language is difficult unlike contents of other types and cannot but rely on an editing work of an editor.

### DISCLOSURE OF INVENTION

### Technical Problem

Therefore, the present invention has been made in view of the above problems, and it is an object of the present invention to provide a method of automatically editing cartoon contents by selecting a language of the cartoon contents or automatically selecting a language according to a connection region and displaying the cartoon contents in a subtitle display area corresponding to the position of a text balloon in an optimum size and ratio.

Another object of the present invention is to provide a method of automatically creating and providing an image for publication of cartoon contents in a multi-lingual version.

Still another object of the present invention is to provide a method of providing cartoon contents on the web and dynamically and automatically editing the cartoon contents according to a selected language.

### Technical Solution

To accomplish the above objects, according to one aspect of the present invention, there is provided a method of automatically editing cartoon contents in multiple languages by a computing device, the method including: a 110-th step of retrieving information on a connection region according to a connection IP address of a client; a 120-th step of loading a page data having a plurality of layers (at least one layer includes a cartoon graphic image, at least one layer has information on a subtitle display area, and at least one layer includes a special effect data) on memory; a 130-th step of retrieving, from a subtitle table, a subtitle data, the maximum number of lines, a horizontal width, horizontal starting coordinates and vertical starting coordinates of a subtitle to be displayed in a text balloon of a current order (at this point, a subtitle data corresponding to the connection region of the client is retrieved); a 140-th step of calculating the number of characters to be inserted in one line using current font size and a value of the retrieved horizontal width; a 150-th step of allocating text corresponding to the subtitle to a remaining subtitle variable and allocating zero to a variable of the current number of lines; a 160-th step of removing text from the remaining subtitle variable as much as the number of characters to be inserted in one line (at this point, text from the starting point of the remaining subtitle variable to the point of finishing a syllable is removed as text of maximum length smaller than the number of characters to be inserted in one line), and updating the current number of lines by adding one to the current number of lines; and a 170-th step of comparing the maximum number of lines and the current number of lines if a value of the remaining subtitle variable does not exist, and processing display of the retrieved subtitle in a corresponding text balloon if the current number of lines is equal to or smaller than the maximum number of lines.

Display of the subtitle is processed by displaying the text included in the subtitle data one line after another starting from the retrieved horizontal and vertical starting coordinates.

Meanwhile, at the 170-th step, the computing device branches to the 140-th step after reducing the font size to a unit size if the current number of lines is larger than the maximum number of lines.

The method may further include a 180-th step of branching to the 130-th step after adding one to a text balloon number when a subtitle of a corresponding text balloon is displayed through such a process.

At this point, a layer having information on an area displaying the subtitle has information on an area corresponding to each of one or more text balloons drawn in the cartoon graphic image layer, and the area included in the information is an area of a rectangular shape identified by a text balloon number.

In this case, at the 130-th step, a subtitle data corresponding to a current text balloon number is retrieved from the subtitle table.

Meanwhile, the special effect data includes vector graphic data configured of text and graphic components.

In this case, the computing device may further execute a 171-th step of displaying a special effect layer by substituting text corresponding to a corresponding connection region of the client retrieved from the subtitle table for default text of the vector graphic data, and a 172-th step of branching to the 171-th step after reducing the font size of the substituted text to a unit size if the vector graphic data goes out of the outer line of a corresponding cut after substitution of text at the 171-th step.

One aspect of the method of automatically editing cartoon contents in multiple languages according to the present invention for accomplishing the above objects is a method of automatically editing and providing cartoon contents on the web.

In this case, at the 170-th step, the computing device automatically creates a web page by overlaying the subtitle on the cartoon graphic image in the form of text.

Meanwhile, another aspect of the method of automatically editing cartoon contents in multiple languages according to the present invention for accomplishing the above objects is a method of providing data of cartoon contents for publication automatically edited in a specific language.

In this case, the computing device creates an output image by displaying text to be overlaid on a cartoon graphic image and merging the text and the cartoon graphic image.

### Advantageous Effects

According to the present invention as described above, cartoon contents may be dynamically and automatically edited in various languages without a manual editing process of an editor.

Particularly, subtitles may be displayed to maintain optimum readability within a range not going out of a text balloon, and a language may be dynamically changed without going out of a cut or damaging or hiding a cartoon image even when a sound effect is displayed.

Accordingly, a publication image of cartoon contents for publication may be automatically edited and created, and there is an effect of allowing publication of a cartoon in a corresponding language version only by simply selecting a language.

Furthermore, cartoon contents provided on the web may be automatically edited and created, and there is an effect of simultaneously providing a service to users in the world using a single source without an editing process of a separate manual work by retrieving a language according to a connection region and dynamically displaying the cartoon contents on the screen.

### BRIEF DESCRIPTION OF THE DRAWINGS

FIG. 1 is a functional block diagram showing the structure of a computing device in which the present invention is executed.

FIG. 2 is a network configuration showing an example of a connection relation of a computing device in which the present invention is executed.

FIG. 3 is a flowchart illustrating a method of automatically editing cartoon contents in multiple languages in time series according to an embodiment of the present invention.

FIG. 4 is a view showing an example of a layout configured of a plurality of cuts and text balloons.

FIG. 5 is a view showing a text balloon and a subtitle display area.

FIG. 6 is a view showing an example of a subtitle displayed in a subtitle display area.

FIG. 7 is a view showing an example of a process of changing a language of sound effect processed in vector graphics.

FIG. 8 is a flowchart illustrating a method of automatically editing cartoon contents in multiple languages in time series according to another embodiment of the present invention.

FIG. 9 is a flowchart illustrating a special effect process in the present invention shown in FIGS. 3 and 8.

DESCRIPTION OF SYMBOLS

| | |
|---|---|
| 100: Computing device | 200: Client |
| 10: Cut | 11: Text balloon |
| 12: Subtitle display area | 13: Sound effect display |

### BEST MODE FOR CARRYING OUT THE INVENTION

Hereafter, the present invention will be described in detail with reference to the preferred embodiments and the accompanying drawings, and it will be described assuming that like reference numerals of the drawings refer to like elements.

If any one of constitutional elements “includes” another constitutional element in the detailed description or the claims of the present invention, it should be understood to further include other constitutional elements, not to be interpreted as being limited to the corresponding constitutional element, as far as an opposed description is not specially specified.

In addition, the constitutional elements named as “˜ means”, “˜ unit”, “˜ module”, “˜ block” and the like in the detailed description or the claims of the present invention means a unit of processing at least one function or operation, and this can be implemented in hardware, software or a combination of hardware and software.

An aspect of the computing device and method disclosed below presents a technique of editing multi-lingual cartoon contents provided on the web.

Another aspect of the computing device and method disclosed below presents a method of automatically editing cartoon contents for publication in multiple languages.

Hereinafter, a computing device means a device which loads a computer program on memory and executes commands included in the computer program through a processor.

For example, the computing device may be understood as a concept generally referring to a personal computer, a server, a smart phone or the like. In addition, if the above definition is satisfied, its shape or name is not limited.

Hereinafter, cartoon contents mean contents of a form in which a picture, a sound effect or a subtitle is displayed inside a cut.

Hereinafter, a cut is a partitioned area, which generally means a unit in which a picture, a sound effect or a subtitle is displayed therein. In the case of cartoon contents manufactured by the unit of page, a plurality of cuts may be included in each page.

Hereinafter, a subtitle means text organized and displayed inside a cut, such as a dialogue, an explanation or the like of a character.

Hereinafter, a text balloon means an area displayed as text inside a cut. Generally, the text balloon is used to display a dialogue of a character. The term of text balloon is used in the present invention for better understanding. However, although an area is not necessarily in the form of a text balloon or is not referred to as a text balloon, if the area represents an area displaying text such as a dialogue, an explanation or the like, it should be understood as a text balloon or an equivalent thereof.

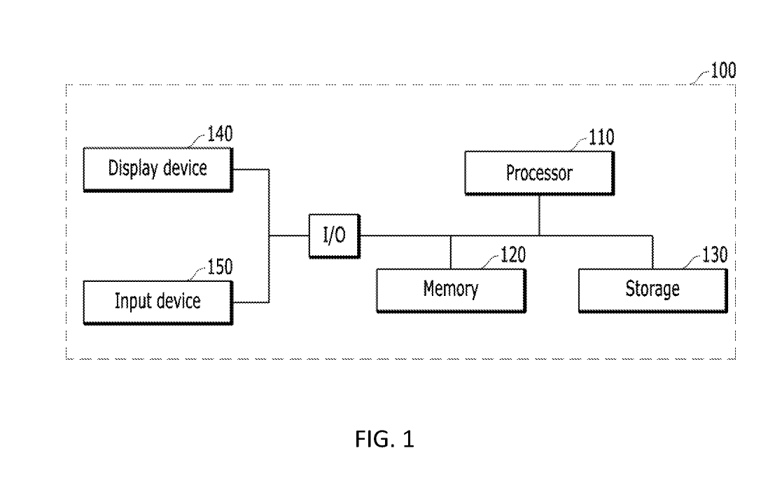

FIG. 1 is a functional block diagram showing the structure of a computing device.

According to the embodiment as shown in FIG. 1, a computing device 100 has a processor 110, a memory 120, a storage 130, a display device 140 and an input device 150.

The processor 110 is generally referred to as a Central Processing Unit (CPU) and executes commands included in a computer program.

The processor 110 retrieves and loads page data and subtitle data on the memory 120 and processes display of cartoon contents according to a language selected in a method described below.

The memory 120 is a space for loading computer program data to be executed. The well-known random access memory (RAM) corresponds thereto.

The storage 130 is a means for storing computer programs and various data, and data stored therein do not perish although supply of power is interrupted. For example, a hard disk drive, a solid state drive, flash memory or the like corresponds thereto.

The storage 130 preferably stores a plurality of page data and a subtitle table.

The subtitle table may include a page number, a text balloon number, a language code and subtitle data interpreted in each language corresponding to each language code.

The display device 140 is a device for visually displaying data, and a Liquid Crystal Display (LCD) monitor, a touch screen or the like corresponds thereto.

The input device 150 is a means for handling the computing device 100 by a user, and a keyboard, a mouse, a joystick or the like corresponds thereto.

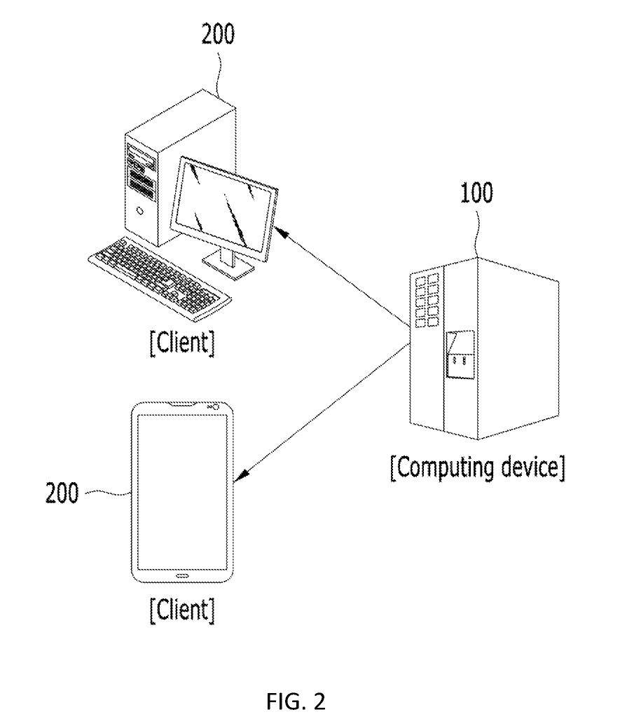

FIG. 2 is a network configuration showing an example of a connection relation of a computing device in which the present invention is executed.

The computing device 100 works standalone to automatically edit cartoon contents in a language selected by handling of a user, and the edited cartoon contents may be published in the form of a publication or web contents.

Alternatively, the computing device 100 may be a form of a server connected to a network such as the Internet and may provide a client 200 connected from a remote site with cartoon contents automatically edited in a language corresponding to the connection region of the client 200 on the web or provide an image for publication of the cartoon contents automatically edited in a specific language for the client 200 connected from a remote site.

The client 200 is a hardware resource for connecting to the computing device 100 from a remote site through a network and may be a form of, for example, a personal computer, a tablet computer or the like.

The present invention may be executed in the computing device 100 or implemented in the form of the computing device 100 as shown in FIGS. 1 and 2.

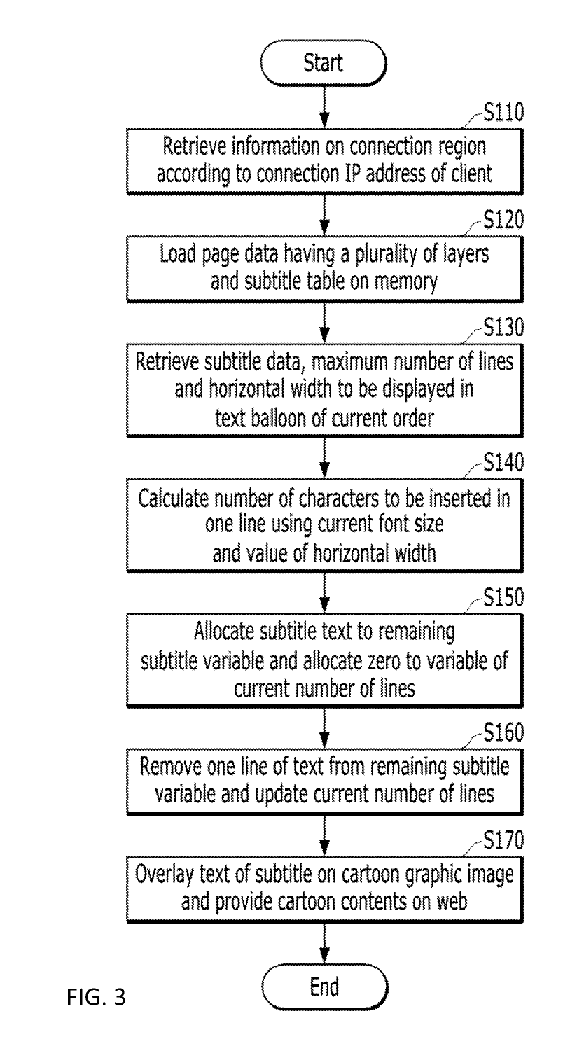

FIG. 3 is a flowchart illustrating a method of automatically editing cartoon contents in multiple languages in time series according to an embodiment of the present invention.

The embodiment of the present invention shown in FIG. 3 describes a method of automatically editing and providing cartoon contents on the web by the computing device 100.

That is, the present invention shown in FIG. 3 may be implemented in the form of a method executed by the computing device 100.

According to the embodiment as shown in FIG. 3, first, the computing device 100 retrieves information on a connection region according to the connection IP address of a client 200 as the client 200 is connected from a remote site (step S110).

This is to retrieve subtitles in a language of a country corresponding to the connection region as described below, and if a function of automatically selecting a language according to a connection region is not needed, subtitles of a specific language set as default are retrieved, and the subtitles may be changed in another language according to selection of a user and automatically edited and provided in the form of web contents.

Then, the computing device 100 retrieves a page data desired to be displayed (step S120).

The cartoon contents provided on the web may be configured of one page displayed to be scrolled long downward or may be configured of several pages.

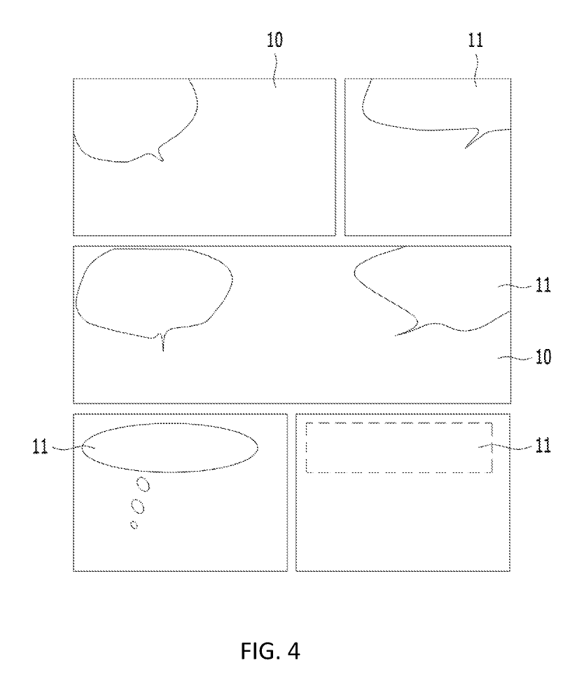

FIG. 4 is a view showing an example of a layout of a page configured of a plurality of cuts and text balloons.

The page shown in FIG. 4 includes a plurality of cuts and text balloons 11 displayed inside each cut.

Meanwhile, the page data preferably has a plurality of layers.

At this point, at least one layer includes a cartoon graphic image.

The cartoon graphic image corresponds to other areas excluding dialogues or sound effects. It may be in colors or black and white and may include the contour or the text balloons 11 of the cut 10.

The cartoon graphic image is a part that does not change in the automatic editing process performed by the computing device 100 and may be regarded as an original copy itself of the contents.

Meanwhile, at least one layer included in the page data has information on an area displaying a subtitle.

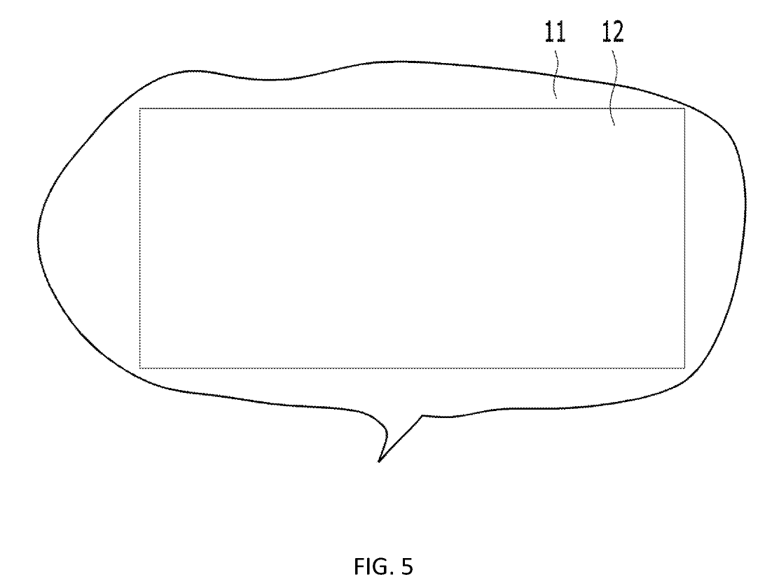

FIG. 5 is a view showing a text balloon and a subtitle display area.

The text balloon 11 drawn in the cut 10 belongs to a cartoon graphic image layer.

Meanwhile, the subtitle display area 12 belongs to a layer having information on the subtitle display area.

At this point, the subtitle display area 12 is an area of a rectangular shape that does not go out of the text balloon 11.

Preferably, the subtitle display area 12 is an area previously set in a proper size within the size of the text balloon 11 or is an automatically set rectangular area.

A process of automatically setting the subtitle display area 12 will be described below separately.

Meanwhile, at least one layer includes a special effect data.

The special effect data is implementation in vector graphics to visually display a sound effect in a cartoon.

At step S120, the computing device 100 retrieves a page data including a plurality of layers and loads the page data on the memory.

Meanwhile, after loading the page data on the memory, the computing device 100 processes in order display of subtitles for the text balloons 11 in a corresponding page.

First, the computing device 100 retrieves a subtitle data, a maximum number of lines, a horizontal width, horizontal starting coordinates and vertical starting coordinates of the subtitle to be displayed in a corresponding text balloon 11 for the first text balloon 11 (step S130).

At this point, the computing device 100 may retrieve a subtitle data corresponding to the connection region of the client 200.

As shown in FIG. 5, a subtitle display area 12 is connected to each text balloon 11, and actually, the computing device 100 processes display of the subtitle in relation to a specific subtitle display area 12.

Each subtitle display area 12 may be identified by a text balloon number.

In addition to the page data, a subtitle table having subtitle data may be further prepared.

The subtitle table may include a page number, a text balloon number, a language code and subtitle data interpreted in each language corresponding to each language code.

The computing device 100 may retrieve a subtitle data corresponding to a text balloon number from the subtitle table.

In addition, a plurality of layers is displayed to be overlapped with each other so that a subtitle may be displayed inside the text balloon 11.

Meanwhile, the subtitle data means text to be displayed in the subtitle display area 12 corresponding to a specific text balloon 11.

The maximum number of lines means a value set in advance to define how many lines of text may be displayed in maximum in a corresponding subtitle display area 12.

The horizontal starting coordinates and the vertical starting coordinates mean coordinates where the subtitle display area 12 begins. For example, the coordinates may be coordinates of the left top vertex among the four vertexes of the subtitle display area 12.

Apparently, the coordinates may be a coordinate point of the right top vertex or the right bottom vertex of the subtitle display area 12 according to the characteristic of a coordinate system or a method of display.

The horizontal width means the horizontal width of the subtitle display area 12.

When the subtitle display area 12 is automatically set, the horizontal width may be automatically calculated in a method described below, instead of setting the horizontal width in advance.

At step S130, a rectangle positioned inside a text balloon of a corresponding order and contacting with the outer line of the text balloon is created.

At this point, a ratio of the horizontal length to the vertical length of the rectangle is determined according to the length of the retrieved subtitle data.

The subtitle data is a data of a text format, and the number of characters may be counted. In addition, a section is determined in advance with respect to the number of characters, and the horizontal length is set to be larger than the vertical length in a section to which the number of characters belongs.

For example, if the number of characters belongs to a maximum section (e.g., the number of characters is larger than sixty), the ratio of the horizontal length to the vertical length may be set to be 4:1. If the number of characters belongs to a next section, the ratio may be set to be 3:1. If the number of characters belongs to a minimum section (e.g., the number of characters is smaller than ten), a rectangle may be created by setting the ratio as 1:1.

The length of the top or bottom side of the rectangle created by determining the horizontal to vertical ratio may be used as the horizontal width.

Meanwhile, the computing device 100 calculates the number of characters to be inserted in one line using the current font size and the value of the retrieved horizontal width (step S140).

If the font size is not changes yet, the current font size becomes the default font size. Each page data may include a value of default font size.

Meanwhile, the number of characters to be inserted in one line calculated like this means the number of syllables that may be maximally displayed in the horizontal width of the subtitle display area 12. In case of doing word spacing, the number of characters may include the number of spaces.

Although a space may be calculated as one character, it may be counted as 0.5 characters according to the size occupied by the space.

Then, the computing device 100 allocates text corresponding to the subtitle to a remaining subtitle variable and allocates zero to the variable of the current number of lines (step S150).

The remaining subtitle variable is a variable used to calculate a font size and the number of lines of the subtitle to be displayed in the subtitle display area 12.

The current number of lines is a variable used to calculate a font size for the best readability without exceeding the maximum number of lines and used to count the line number of the current line.

Then, the computing device 100 removes text from the remaining subtitle variable as much as the number of characters to be inserted in one line and updates the current number of lines by adding one to the current number of lines (step S160).

At this point, in the case of a language having word spacing, text from the starting point of the remaining subtitle variable to the point of finishing a syllable is removed, instead of removing text as much as the number of characters, as text of the maximum length smaller than the number of characters to be inserted in one line.

That, the text is cut in front of a word space and continued to the next line.

This process is repeated until the value of the remaining subtitle variable does not exist.

That is, the process described above is repeated until the text allocated to the remaining subtitle variable is completed removed.

Meanwhile, if a value of the remaining subtitle variable does not exist, the computing device 100 compares the maximum number of lines and the current number of lines.

If the current number of lines is equal to or smaller than the maximum number of lines, the computing device 100 processes display of the retrieved subtitle in a corresponding text balloon (step S170).

Display of the subtitle is processed by displaying the text included in the subtitle data one line after another starting from the retrieved horizontal and vertical starting coordinates.

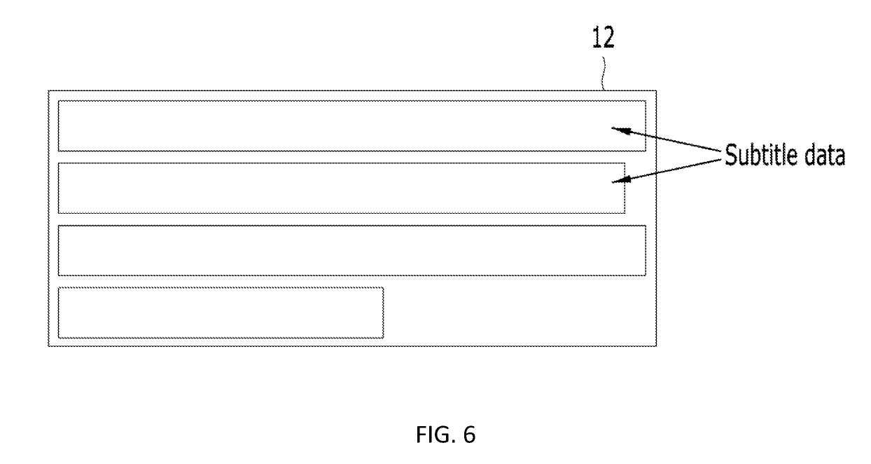

FIG. 6 conceptually illustrates a view of displaying a subtitle in several lines divided in the subtitle display area.

FIG. 6 shows an example of a language having word spacing. It is understood that the length of each line is slightly different from the others.

If dividing a sentence into several lines succeeds considering word spacing in a default font size, the subtitle data is divided in a proper length and displayed on the screen as shown in the above example.

However, all the subtitle data may not be displayed in the subtitle display area 12 in the default font size.

That is, at step S170, if the current number of lines is larger than the maximum number of lines, the computing device 100 reduces the font size to a unit size and branches to step S140.

For example, after reducing the font size as much as two, the computing device 100 branches to step S140 and repeats the steps of cutting and diving the subtitle into text of the maximum length that will be inserted in each line.

Through these steps, all the subtitle data are displayed in each subtitle display area 12 in a maximum font size.

When a subtitle of a corresponding text balloon is displayed, the computing device 100 branches to step S130 after adding one to the text balloon number.

That is, the subtitle process is performed for all text balloons included in a corresponding page data.

This embodiment relates to automatically editing cartoon contents in the form of contents provided on the web, and at step S170, the computing device 100 automatically creates a web page by overlaying the subtitle on the cartoon graphic image in the form of text.

Meanwhile, the second embodiment of the present invention relates to a method of providing data of cartoon contents for publication automatically edited in a specific language.

Unlike the first embodiment, automatic language conversion according to a connection region is unnecessary.

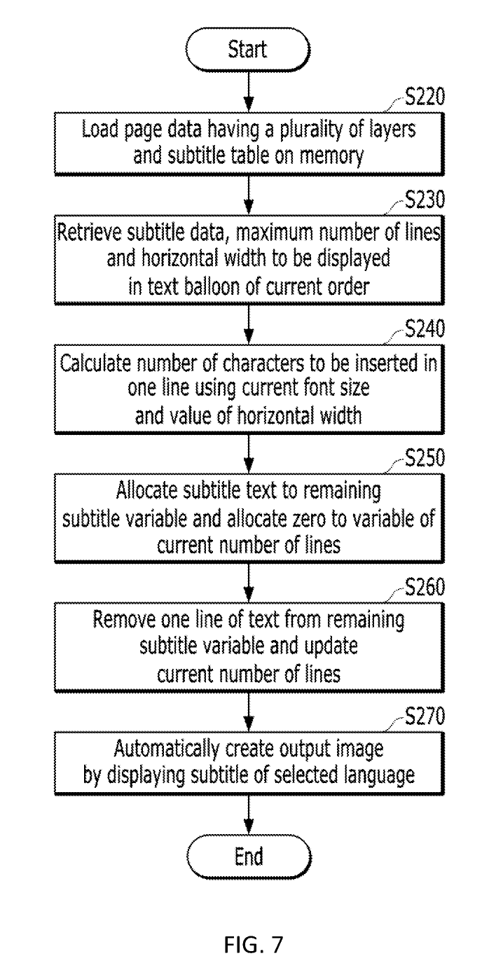

Accordingly, the computing device 100 sequentially executes steps S220 to S270 as shown in FIG. 7. Steps 220 to 260 are identical to the steps 120 to 160 of the first embodiment.

Meanwhile, this embodiment relates to a technique of automatically editing and providing data for publication, and at step S270, the computing device 100 creates an output image by displaying text to be overlaid on a cartoon graphic image and merging the text and the cartoon graphic image.

Hereinafter, in processing display of subtitle data at step S270, a step of processing a special effect is added.

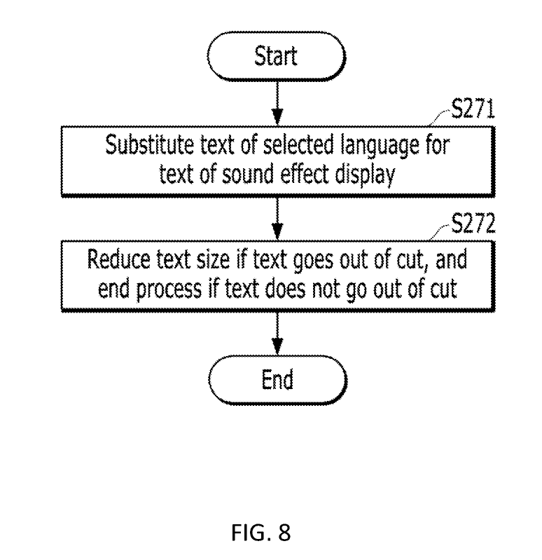

FIG. 8 is a flowchart adding a step of processing a special effect to the first and second embodiments of the present invention as described above.

A page data includes a special effect data layer, and at this point, the special effect data layer includes vector graphic data configured of text and graphic components.

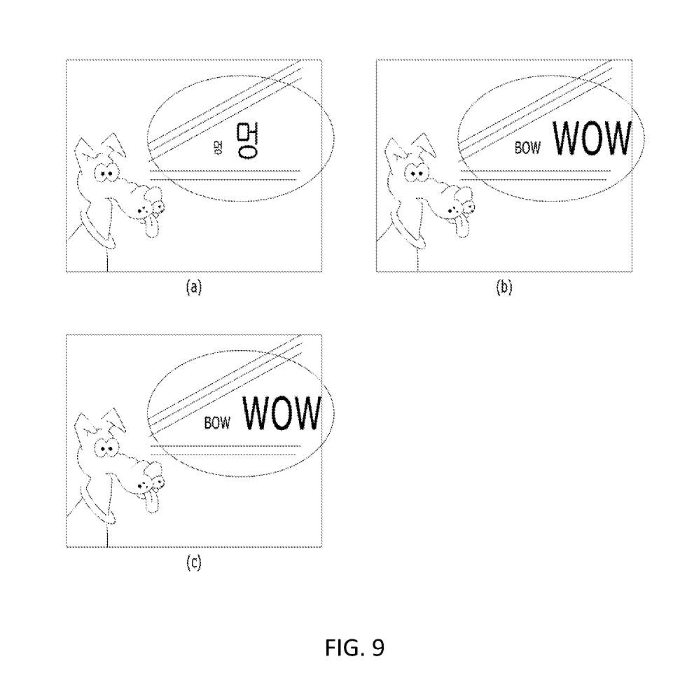

A special effect is visually displaying a sound effect to further realistically express a cartoon, and it is typical that the special effect is configured of several strands of lines and an onomatopoeia such as “ [symbol] ” which is korean expression of onomatopoeia equivalent to bowwow as shown in FIG. 9(a).

First, the computing device 100 substitutes text retrieved from the subtitle table and corresponding to a corresponding connection region of the client 200 for default text of the vector graphic data (step 271).

It is understood that “ [symbol] ” is changed to “Bowwow” as shown in FIG. 9(b).

However, although Korean language “ [symbol] ” is only two syllables, “Bowwow” is configured of six alphabet letters, and thus the length of “Bowwow” much larger.

Accordingly, in FIG. 9(b), a corresponding sound effect display 13 goes out of the cut 10.

Accordingly, as the vector graphic data goes out of the outer line of a corresponding cut after substitution of text, the computing device 100 branches to step S271 after reducing the font size to a unit size (step S272).

Through these steps, language conversion of the sound effect display 13 is automatically processed without going out of the cut 10 as show in FIG. 9(c).

In processing a subtitle “the subtitle display layer at step S270, the computing device 100 performs a separate process on a special effect layer and finishes the automatic multi-lingual editing process by displaying the layers to be overlapped with each other.

The method of automatically editing cartoon contents in multiple languages according to an embodiment of the present invention may be implemented in the form of a program command that can be performed through various computer means and may be recorded in a computer-readable medium. The computer-readable medium may include program commands, data files, data structures and the like individually or in combination. The program commands recorded in the medium may be commands specially designed and configured for the present invention or commands publicized and used by those skilled in the art of computer software. Examples of the computer-readable recording medium include magnetic media such as a hard disk, a floppy disk and a magnetic tape, optical media such as CD-ROM and DVD, magneto-optical media such as a floptical disk, and hardware devices specially configured to store and perform the program commands, such as ROM, RAM, flash memory and the like. Examples of the program commands include a high-level language code that can be executed by a computer using an interpreter or the like, as well as a machine language code produced by a compiler.

While the embodiments of the present invention have been described above in detail, the scope of the present invention is not limited thereto, and various modified and improved forms made by those skilled in the art using basic concepts of the present invention defined in the appended claims also fall within the scope of the present invention.

1. A method of automatically editing cartoon contents in multiple languages by a computing device, the method comprising:
a 120-th step of loading a page data having a plurality of layers on memory, wherein at least one layer includes a cartoon graphic image, and at least one layer has information on a subtitle display area;
a 130-th step of retrieving, from a subtitle table, a subtitle data, the maximum number of lines and a horizontal width of a subtitle to be displayed in a text balloon of a current order;
a 140-th step of calculating the number of characters to be inserted in one line using current font size and a value of the retrieved horizontal width;
a 150-th step of allocating text corresponding to the subtitle to a remaining subtitle variable and allocating zero to a variable of the current number of lines;
a 160-th step of removing text from the remaining subtitle variable as much as the number of characters to be inserted in one line, and updating the current number of lines by adding one to the current number of lines; and
a 170-th step of comparing the maximum number of lines and the current number of lines if a value of the remaining subtitle variable does not exist, and processing display of the retrieved subtitle in a corresponding text balloon if the current number of lines is equal to or smaller than the maximum number of lines, wherein
the 170-th step further includes a 171-th step of displaying a special effect layer by substituting text corresponding to a corresponding connection region of a client retrieved from the subtitle table for default text of a vector graphic data, and at least one layer among the layers of the page data includes a special effect data, and the special effect data includes the vector graphic data configured of text and graphic components.

2. The method according to claim 1, wherein a layer having information on an area displaying the subtitle has information on a subtitle display area corresponding to each of one or more text balloons drawn in the cartoon graphic image layer, wherein the subtitle display area included in the information is an area of a rectangular shape identified by a text balloon number, and at the 130-th step, a subtitle data corresponding to a current text balloon number is retrieved from the subtitle table.

3. The method according to claim 1, further comprising a 172-th step of branching to the 171-th step after reducing a font size of the substituted text to a unit size if the vector graphic data goes out of an outer line of a corresponding cut after substitution of text at the 171-th step.

4. The method according to claim 1, wherein at the 170-th step, a web page is automatically created by overlaying the subtitle on the cartoon graphic image in a form of text.

5. The method according to claim 1, wherein at the 170-th step, an output image is created by displaying text to be overlaid on a cartoon graphic image and merging the text and the cartoon graphic image.

6. The method according to claim 1, wherein horizontal starting coordinates and vertical starting coordinates are further retrieved at the 130-th step, and text included in the subtitle data is displayed one line after another starting from the retrieved horizontal and vertical starting coordinates at the 170-th step.

7. The method according to claim 1, wherein at the 160-th step, text from a starting point of the remaining subtitle variable to a point of finishing a syllable is removed as text of maximum length smaller than the number of characters to be inserted in one line.

8. The method according to claim 1, wherein the computing device branches to the 140-th step after reducing the font size to a unit size if the current number of lines is larger than the maximum number of lines at the 170-th step.

9. The method according to claim 1, further comprising, before the 130-th step, a 110-th step of retrieving information on a connection region according to a connection IP address of the client, wherein a subtitle corresponding to a corresponding connection region is retrieved from the subtitle table at the 130-th step.

10. The method according to claim 1, further comprising, after the 170-th step, a 180-th step of branching to the 130-th step after adding one to a text balloon number.
